(19) United States
(12) Patent Application Publication
(10) Pub. No.: US 2024/0027617 A1
(43) Pub. Date: Jan. 25, 2024

(54) PORTABLE TERMINAL AND ELECTRONIC GLASSES

(71) Applicant: MAXELL, LTD., Kyoto (JP)

(72) Inventors: Osamu KAWAMAE, Kyoto (JP); Mayumi NAKADE, Kyoto (JP); Hitoshi AKIYAMA, Kyoto (JP)

(21) Appl. No.: 18/255,914

(22) PCT Filed: Dec. 10, 2020
(86) PCT No.: PCT/JP2020/046038

§ 371 Date: Jun. 5, 2023

(51) Int. Cl. G01S 17/10; G01S 17/894; G01S 7/48; G01S 7/481; G01S 7/51

(52) U.S. Cl. CPC G01S 17/10; G01S 17/894; G01S 7/4808; G01S 7/4813; G01S 7/51; H04M 1/026

(57) ABSTRACT

A portable terminal comprises a distance measurement device capable of treasuring a distance of a first distance measurement range and a distance of a second distance measurement range different from the first distance measurement range, and a processor configured to determine a distance to an object based on a result of distance measurement by the distance measurement device and output the result as a distance measurement value. The present invention relates to one of the sustainable development goals which concerns building “Infrastructure, Industrialization, and Innovation”.

### TECHNICAL FIELD

The present invention relates to a portable information processing terminal equipped with a ranging sensor.

### BACKGROUND ART

There has been known a portable type of information processing terminal (portable information processing terminal, portable terminal), typically such as a smartphone, which is equipped with a plurality of cameras mounted on the same surface thereof. Such cameras are, for example, wide-angle camera and ultra-wide-angle cameras. Images captured by these cameras are used in processing such as an AR (Augmented Reality) process. In order to carry out such an AR process, distance needs to be measured with high accuracy.

For ranging sensors, techniques called TOF (Time Of Flight) and LiDAR (Light Detection and Ranging) are adaptable. For example, Patent Literature 1 discloses a technique of providing a vehicle such as an automobile with a plurality of LiDAR sensors of the same type.

Ranging sensors are also used in portable terminals for recognition of gesture instructions. For example, Patent Literature 2 discloses a technique for a head-mounted image display device, in which a ranging sensor is installed in the center of an eyeglass portion for distance measurement.

### CITATION LIST

### Patent Literature

Patent Literature 1: JP-A-2018-072322
Patent Literature 2: JP-A-2019-129327

### SUMMARY OF INVENTION

### Technical Problem

In the technique disclosed in Patent Literature 1, a plurality of LIDAR sensors of the same type is provided. However, depending on the sensors and systems to be used, a measurement range of LIDAR is limited. There is no problem when, for example, applying the technique in automobiles, a distance measurement range or uses of a distance value as obtained is almost limited. However, practically, portable terminals are used in greatly different ways by different users, which makes accurate measurement difficult depending on the distance to an object. Furthermore, sensors having complicated configurations or large-sized sensors cannot be mounted on portable terminals due to restrictions on the size and weight of the devices.

The present invention has been made in view of the above, and an object of the present invention is to provide a technique for accurately measuring distance of a wide range in any use of a device.

### Solution to Problem

The present invention provides a portable terminal, comprising a distance measurement device capable of measuring a distance of a first distance measurement range and a distance of a second distance measurement range different from the first distance measurement range, and a processor configured to determine a distance to an object based on a result of distance measurement by the distance measurement device and output the result as a distance measurement value.

### Advantageous Effects of Invention

According to the present invention, it is possible to accurately measure distance of a wide range in any use of a device. The problems, configurations, and advantageous effects other than those described above will be clarified by explanation of the embodiments below.

### BRIEF DESCRIPTION OF DRAWINGS

FIG. 1A, FIG. 1B, FIG. 1C are back surface, front surface, and side surface views of a smartphone, respectively, according to a first embodiment.

FIG. 2 is a hardware configuration diagram of a smartphone of the first embodiment.

FIG. 3 is a functional block diagram of a smartphone of the first embodiment.

FIG. 4A to FIG. 4D are diagrams for explaining distance measurement ranges and areas of a distance sensor according to the first embodiment, and relation between an imaging distance and imaging field of view of a camera.

FIG. 5A to FIG. 5B are diagrams for explaining direct TOF and indirect TOF systems, respectively.

FIG. 6A to FIG. 6D are diagrams for explaining the principle of distance measurement by LiDAR using a MEMS element.

FIG. 7 illustrates a flowchart of a distance measurement process according to the first embodiment.

FIG. 8 illustrates a flowchart of a distance measurement process according to a modification of the first embodiment.

FIG. 9A is a side surface view of a smartphone according to a modification of the first embodiment, and

FIG. 9B and FIG. 9C are back surface and side surface views of a smartphone according to another modification of the first embodiment.

FIG. 10 is a diagram for explaining the principle of measurement by LiDAR using a pattern light emission system.

FIG. 11A and FIG. 11B are diagrams for explaining a modification of the first embodiment.

FIG. 12A to FIG. 12C are diagrams for explaining a modification of the first embodiment.

FIG. 13A and FIG. 13B are diagrams for explaining a modification of the first embodiment.

FIG. 14A and FIG. 14B are a back surface view and side surface view of a smartphone, respectively, according to a second embodiment.

FIG. 15 is a hardware configuration diagram of a smartphone according to the second embodiment.

FIG. 16 is a functional block diagram of a smartphone according to the second embodiment.

FIG. 17A and FIG. 17B are diagrams for explaining scanning ranges according to the second embodiment.

FIG. 18 illustrates a flowchart of a distance measurement process according to the second embodiment.

FIG. 19A and FIG. 19B are diagrams for explaining a modification of the first and second embodiments.

FIG. 20A and FIG. 20B are diagrams for explaining a modification of the first and second embodiments.

### DESCRIPTION OF EMBODIMENTS

Referring to the drawings, embodiments of the present invention will be described. Note that the same reference signs used in the drawings denote the same functions and processes. Techniques described in the embodiments of the present invention below enables highly accurate distance measurement. The distance measurement technology according to the present invention contributes to “9. Industry, Innovation and Infrastructure” of the Sustainable Development Goals (SDGs) advocated by the United Nations.

### First Embodiment

A first embodiment of the present invention will be described. In the present embodiment, an example of a portable terminal equipped with, on the same surface, a plurality of cameras for imaging distance which differ from each other will be described. Hereinafter, in the present embodiment, a smartphone will be exemplified as a portable terminal. The smartphone according to the present embodiment is equipped with, on the same surface as that equipped with the plurality of cameras, a plurality of distance sensors of which measurable distance ranges (distance measurement ranges) are different from each other. These distance sensors are separately and properly used depending on the distance to an object to be measured.

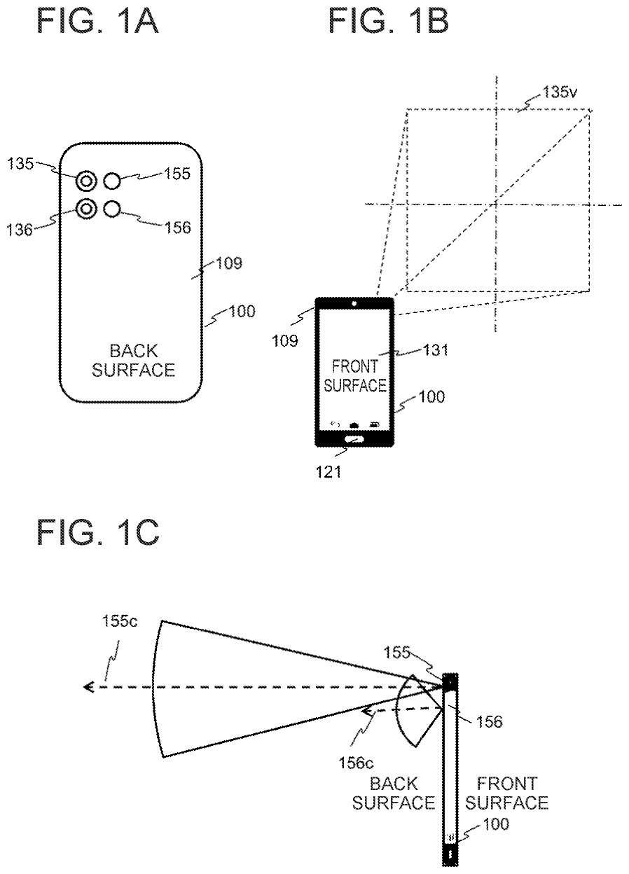

First, an outline of the present embodiment and appearance of a smartphone 100 will be described. FIG. 1A is a back surface view of the smartphone 100, FIG. 1B is a front surface view, and FIG. 1C is a side surface view. In the following, elements relating to the present embodiment will be mainly described.

The smartphone 100 includes a casing 109 in which each unit of the smartphone 100 is housed. In the following, the upper and lower direction and left and right direction are as illustrated.

As illustrated in FIG. 1A, the smartphone 100 includes, on the back surface, a first camera 135, a second camera 136, a first distance sensor 155, and a second distance sensor 156. As illustrated in FIG. 1B, the smartphone 100 includes, on the front surface, a display 131, an operation key 121, and the like. In FIG. 1B, an imaging range (imaging field of view 135v) of the first camera 135 is illustrated with broken lines.

The display 131 is a touch screen formed with a combination of a display device such as a liquid crystal panel and a position input device such as a touch pad. The display 131 also functions as a finder of the first camera 135 and second camera 136.

In the present embodiment, as illustrated in FIG. 1A, the first distance sensor 155 and the second distance sensor 156 are installed at the positions which are the same in the longitudinal direction (upper and lower direction) of the smartphone 100 as those of the first camera 135 and the second camera 136, respectively.

The first distance sensor 155 is a middle-distance sensor for a measurement range of middle-distance. The second distance sensor 156 is a short-distance sensor for a measurement range of short distance. Referring to FIG. 1C, distance measurement ranges of the first distance sensor 155 and second distance sensor 156 will be described.

As illustrated in FIG. 1C, in the present embodiment, a direction of the center of distance measurement (distance measurement direction 155c) of the middle-distance sensor (first distance sensor 155) and a distance measurement direction 156c of the short-distance sensor (second distance sensor 156) are directed the same as an optical axis direction of the first camera 135 and the optical axis direction of the second camera 136, respectively. This enables highly accurate acquisition of the distance to an object in an image captured by each of the cameras.

### [Hardware Configuration]

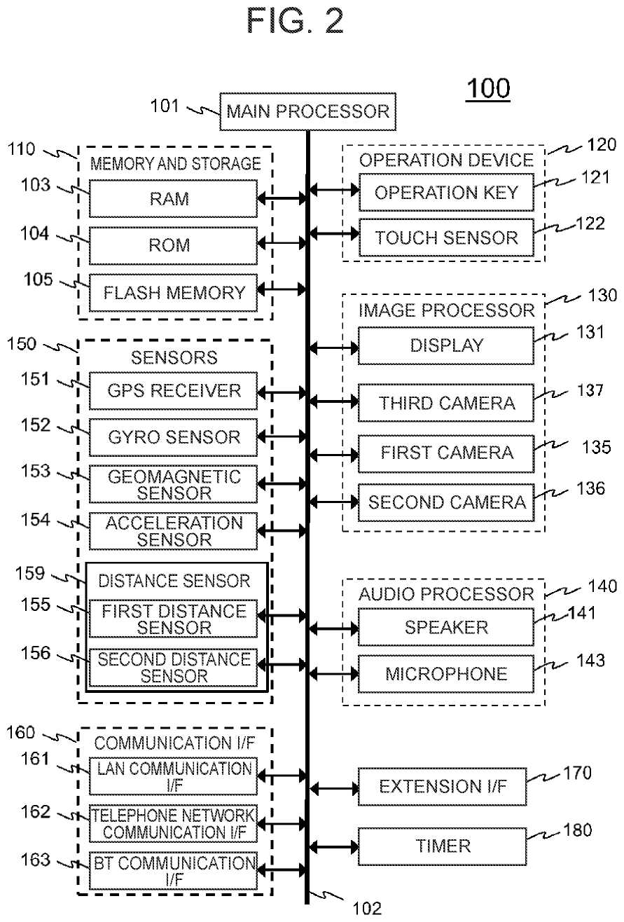

Next, a hardware configuration of the smartphone 100 according to the present embodiment will be described. FIG. 2 is a hardware configuration diagram of the smartphone 100 according to the present embodiment.

As illustrated in FIG. 2, the smartphone 100 includes a main processor 101, a system bus 102, a memory and storage 110, an operation device 120, an image processor 130, an audio processor 140, sensors 150, communication interface (I/F) 160, an extension interface (I/F) 170, and a timer 180.

The main processor 101 is a main controller that controls the overall operations of the smartphone 100 in accordance with predetermined programs. The main processor 101 is implemented by a CPU (Central Processor Unit) or a microprocessor unit (MPU). The main processor 101 executes processes in accordance with a clock signal measured and output by the timer 180.

The system bus 102 is a data communication channel for transmitting and receiving data between the main processor 101 and each section provided in the smartphone 100.

The memory and storage 110 stores data necessary for processes executed by the main processor 101, data generated by the processes, and the like therein. The memory and storage 110 includes a RAM 103, a ROM 104, and a flash memory 105.

The RAM 103 is a program area during execution of a basic operation program or other application programs. The RAM 103 is a temporary storage area for temporarily retaining data as necessary. The RAM 103 may be integrated with the main processor 111.

The ROM 104 and the flash memory 105 store operation settings of the smartphone 100, information about a user of the smartphone 100, and the like therein. The ROM 104 and the flash memory 105 may store image data, movie data, and the like captured by the smartphone 100. It is assumed that the functions of the smartphone 100 can be extended by downloading a new application program from an application server through the Internet. At this time, the new application program as downloaded is stored in the ROM 104 and the flash memory 105. The main processor 101 loads the new application program stored in the ROM 104 and flash memory 105 and executes it on the RAM 103, whereby the smartphone 100 can implement various functions. Instead of the ROM 104 and the flash memory 105, devices such as an SSD (Solid State Drive) and an HDD (Hard Disc Drive) may be used.

The operation device 120 receives an input of an operation instruction to the smartphone 100. In the present embodiment, the operation device 120 includes operations key 121 such as a power key, a volume key, and a home key. The operation device 120 further includes a touch sensor 122 for receiving an operation instruction by means of the touch pad. The touch sensor 122 is provided as a touch panel and arranged to overlap on the display 131 which will be described later. Note that the smartphone 100 according to the present embodiment does not necessarily have to include all these of the operation device 120. The power key may be arranged, for example, on the front surface, one of the side surfaces, or other positions of the casing 109.

An input of an instruction may be accepted via a keyboard or the like connected to the extension interface 170 which will be described later. An operation instruction to the smartphone 100 may be accepted via a separate information processing terminal device connected by wired or wireless communication.

The image processor 130 includes a processor for images (videos), and further includes the display 131, the first camera 135 that is a first image acquisition section, the second camera 136 that is a second image acquisition section, and a third camera 137. The third camera 137 is provided on the front surface.

The display 131 is, for example, a display device such as a liquid crystal panel, and presents image data processed by the image processor to a user of the smartphone 100. For the case that the portable terminal is a head-mounted display (HMD), the display 131 may be a see-through type display.

Images acquired by the first camera 135, the second camera 136, and the third camera 137 are processed by an image (video) signal processor or the main processor 101, and objects generated by the main processor 101 or the like are superimposed thereon and output to the display 131.

The first camera 135 and the second camera 136 are back face cameras (out-cameras) that acquire images around the smartphone 100. On the other hand, the third camera 137 acquires images in a direction different from the directions of the first camera 135 and second camera 136. For example, the third camera 137 is a front face camera (in-camera) that captures images of the face and eye of a user. When the portable terminal is an HMD, the third camera 137 functions as, for example, a line-of-sight sensor.

The audio processor 140 includes an audio signal processor for audio processing, and further includes a speaker 141 that is an audio output section and a microphone 143 that is an audio input section. Each speaker 141 is installed, for example, in the center of the upper portion of the display 131 that is provided on the front surface of the casing 109 and the lower portion of the back surface of the casing 109. The speaker 141 installed on the upper portion of the front surface of the casing 109 is a monaural speaker, and is used for voice calls. The speaker 141 installed at the lower portion of the back surface of the casing 109 is a stereo speaker, and is used for playing movies and the like. The microphone 143 is installed, for example, on the lower surface of the casing 109.

The sensors 150 forms a group of sensors for detecting a state of the smartphone 100. In the present embodiment, the sensors 150 includes a distance sensor 159 with the two sensors described above (first distance sensor 155 and second distance sensor 156), a GPS (Global Positioning System) receiver 151, a gyro sensor 152, a geomagnetic sensor 153, and an acceleration sensor 154. These sensors are used to detect the position, motion, tilting, direction, and the like of the smartphone 100. The distance sensor 159 is a depth sensor, and is a ranging device for acquiring distance information from the smartphone 100 to an object. Hereinafter, the first distance sensor 155 and the second distance sensor 156 are collectively referred to as the distance sensor 159 when they do not have to be distinguished to each other. The distance sensor 159 will be described in detail later. Note that the sensors 150 may further include other sensors.

The communication I/F 160 is a communication processor for communication processing. For example, the communication I/F 160 includes a LAN (Local Area Network) communication I/F 161, a telephone network communication I/F 162, and a BT (Bluetooth (registered trademark) communication I/F 163. The LAN communication I/F 161 is connected to access points for the Internet wireless communication by wireless communication, thereby transmitting and receiving data. The telephone network communication I/F 162 wirelessly communicates with a base station of a mobile telephone communication network, thereby performing telephone communication (call) and transmission and reception of data. The BT communication I/F 163 is an interface for communication with an external device by Bluetooth standard. Each of the LAN communication I/F 161, the telephone network communication I/F 162, and the BT communication I/F 163 includes an encoding circuit, a decoding circuit, an antenna, and the like. The communication I/F 160 may further include an infrared communication I/F and the like.

The extension interface 170 forms a group of interfaces for extending the functions of the smartphone 100, and in the present embodiment, includes a charging terminal, a video and audio interface, a USB (Universal Serial Bus) interface, a memory interface, and the like. The video and audio interface inputs video signals and audio signals output from an external video and audio output device, and outputs video signals and audio signals to an external video and audio input device. The USB interface is used for connection to a keyboard and other USB devices. The memory interface is used for connection with a memory card and other memory media and thus transmission and reception of data. The USB interface is provided, for example, on the lower surface of the casing 109.

The smartphone 100 may include, in addition to the above, a fingerprint sensor to be arranged on the back surface of the casing 109, an LED to be arranged on the upper portion of the display 131 that is provided on the front surface of the casing 109, and the like.

Note that a part of the exemplary configuration of the smartphone 100 illustrated in FIG. 2 is not essential to the present embodiment. Accordingly, even if the configuration of the smartphone 100 does not include such an unessential component, the advantageous effects of the present embodiment are not impaired.

### [Function Block]

Next, a functional configuration of the smartphone 100 according to the present embodiment will be described. In the smartphone 100 according to the present embodiment, the distance sensor 159 to be used is switched depending on the distance to an object to be measured. The functional configuration of the smartphone 100 according to the present embodiment will be mainly described with respect to the features relating to the present embodiment.

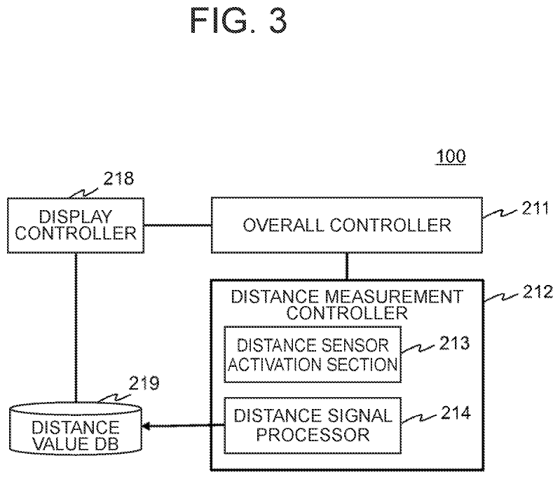

FIG. 3 is a functional block diagram of the smartphone 100 according to the present embodiment. As illustrated in FIG. 3, the smartphone 100 includes an overall controller 211, a distance measurement controller 212, a display controller 218, and a distance value database (DB) 219. The distance measurement controller 212 includes a distance sensor activation section 213 and a distance signal processor 214. The main processor 101 loads programs stored in the memory and storage 110 onto the RAM 103 and executes them, whereby each of these functions is realized. The distance value DB 219 is stored in the memory and storage 110.

The overall controller 211 controls the overall operations of the smartphone 100. The display controller 218 controls a display process for the display 131. In the present embodiment, the display controller 218 controls the display process using a distance value, which will be described later, obtained by the control by the distance measurement controller 212.

The distance measurement controller 212 controls distance measurement by the distance sensor 159. In the present embodiment, the distance measurement controller 212 controls activation and driving of the first distance sensor 155 and second distance sensor 156, and acquires a distance value (distance measurement value) as the distance to an object. In the present embodiment, the distance measurement controller 212 controls the distance sensor activation section 213 and the distance signal processor 214 in order to realize the functions above.

The distance sensor activation section 213 activates the first distance sensor 155 and the second distance sensor 156. In the present embodiment, upon receiving an instruction to activate the smartphone 100 or to activate the distance sensor from a user, the distance sensor activation section 213, firstly, causes the first distance sensor 155, which is a middle-distance sensor, to operate. Then, upon receiving an NG signal from the first distance sensor 155, the distance sensor activation section 213 causes the second distance sensor 156 to operate. NG signals will be described later.

When a sensor signal (distance value) received from the first distance sensor 155 or second distance sensor 156 is not a NG signal, the distance signal processor 214 outputs the sensor signal as a distance measurement value of the distance sensor 159. Furthermore, the distance signal processor 214 stores, in the distance value DB 219 of the memory and storage 110, the distance value in association with, for example, the time of measurement and two-dimensional position thereof.

### [Distance Sensor]

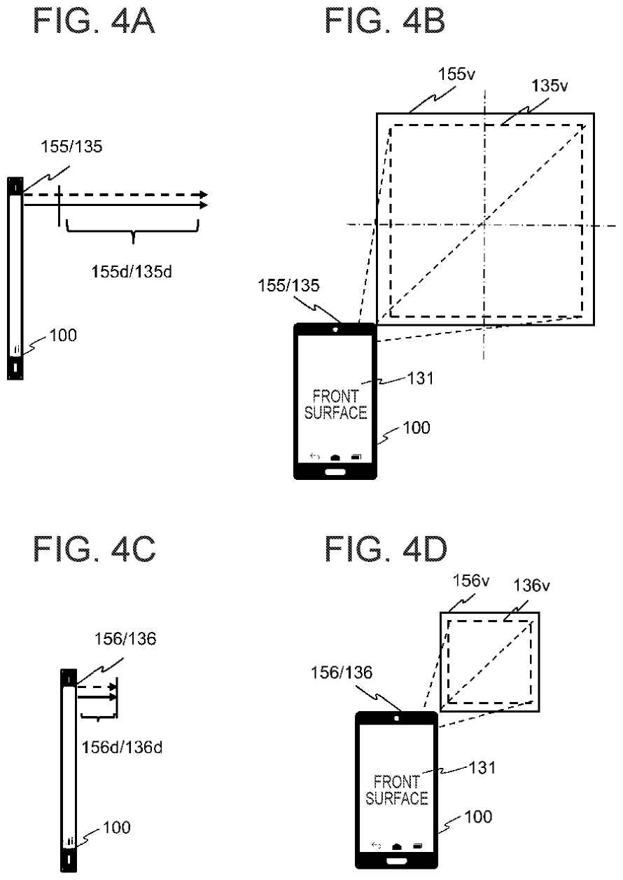

Here, the first distance sensor 155 and the second distance sensor 156 will be described more in detail. In the present embodiment, as illustrated in FIG. 4A, a range measurable by the first distance sensor 155 (first distance measurement range 155d) is based on an imaging distance 135d of the first camera 135. The imaging distance and the distance measurement range include infinity. Furthermore, as illustrated in FIG. 4B, the first distance sensor 155 can measure distance within a first distance measurement area 155v including the imaging field-of-view 135v of the first camera 135. As illustrated in FIG. 4C, a range measurable by the second distance sensor 156 (second distance measurement range 156d) is based on an imaging distance 136d of the second camera 136. Furthermore, as illustrated in FIG. 4D, the second distance sensor 156 can measure distance within a second distance measurement area 156v including the imaging field-of-view 136v of the second camera 136.

The imaging field of view 135v of the first camera 135 and the first distance measurement area 155v of the first distance sensor 155 are associated with each other in advance and stored in the memory and storage 110. This enables calculation of a distance value of an object corresponding to each pixel position of the first camera 135. The same applies to the second camera 136 and the second distance sensor 156.

In order to realize the functions above, in the present embodiment, LiDAR sensors by TOF systems are used as the first distance sensor 155 and second distance sensor 156. A LiDAR sensor by a TOF system irradiates a laser light from a laser light source, and measures the distance from the sensor to an object using the light reflected on the object.

The first distance measurement range 155d of the first distance sensor 155 is a range for middle-distance from the smartphone 100, which is, for example, a range from 30 cm to from the smartphone 100. When an object is within the first distance measurement range 155d, the first distance sensor 155 outputs a value of the distance between the first distance sensor 155 and the object as a distance measurement value. On the other hand, when an object is nearer than the first distance measurement range 155d and the distance thereof cannot be measured by the first distance sensor 155, the first distance sensor 155 outputs an NG value. When an object is further than the first distance measurement range 155d, the first distance sensor 155 assumes that the distance is measured as 5 m or more.

The first distance sensor 155 is configured with, for example, a LiDAR (Light Detection And Ranging) sensor using a direct TOF (Time Of Flight) system. In the direct TOF system, a pulse laser light is irradiated and the time until reflection of the light is detected is observed. Using a direct TOF system generally enables measurement of the distance to an object about 5 m away both indoors or outdoors.

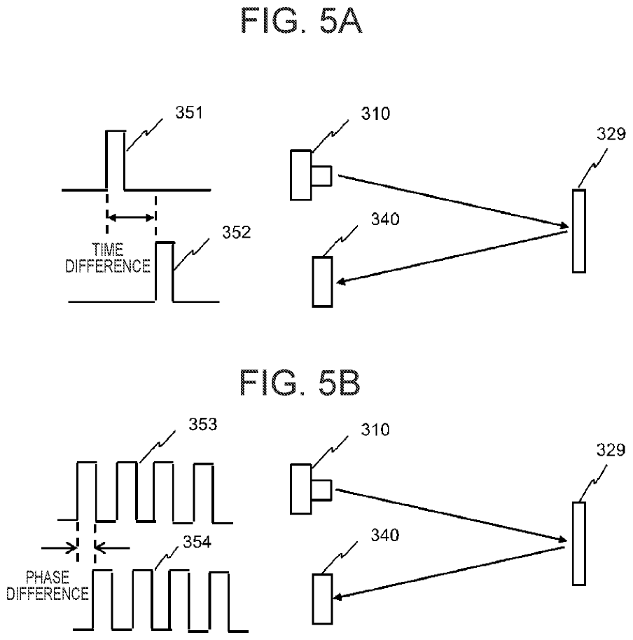

FIG. 5A illustrates an outline of the first distance sensor 155. As illustrated in FIG. 5A, the first distance sensor 155 includes a light emitting portion 310 including a laser light source that irradiates a laser light, and a light receiving portion 340 including a light receiving element that receives the laser light reflected on an object 329. The light emitting portion 310 emits a pulse laser light 351, and the light receiving element of the light receiving portion 340 receives a reflection light 352 reflected on the object 329. The first distance sensor 155 calculates the time necessary for round trip of the pulse laser light based on a time difference between these pulses, and estimates the distance.

The second distance measurement range 156d of the second distance sensor 156 is a range for short distance around the smartphone 100, which is, for example, a range within 30 cm from the smartphone 100. When an object is within the second distance measurement range 156d, the second distance sensor 156 outputs a value of the distance between the second distance sensor 156 and the object as a distance measurement value. On the other hand, when the object is out of the second distance measurement range 156d, the second distance sensor 156 outputs an NG value.

The second distance sensor 156 is configured with, for example, a LiDAR sensor using an indirect TOF system. In the indirect TOF system, a phase difference of the frequency of a light is converted into a time difference, and the time difference is multiplied by the velocity to calculate the distance to an object to be measured.

FIG. 5B illustrates an outline of the second distance sensor 156. As illustrated in FIG. 5B, the second distance sensor 156 includes the light emitting portion 310 that emits a laser light, and a light receiving portion 340 that receives the laser light reflected on the object 329. In the second distance sensor 156, the light emitting portion 310 emits a laser light (emission light 353) having a periodic pulse, and the light receiving portion 340 receives a reflection light 354. The second distance sensor 156 estimates distance based on the phase difference between the emission light 353 and the reflection light 354.

The first distance sensor 155 and the second distance sensor 156 are not limited thereto. The first distance sensor 155 and the second distance sensor 156 may be, for example, sensors that obtain distance by machine-learning of the size of an object using a millimeter wave radar or a camera image as long as they are capable of measuring distance within a predetermined distance measurement range.

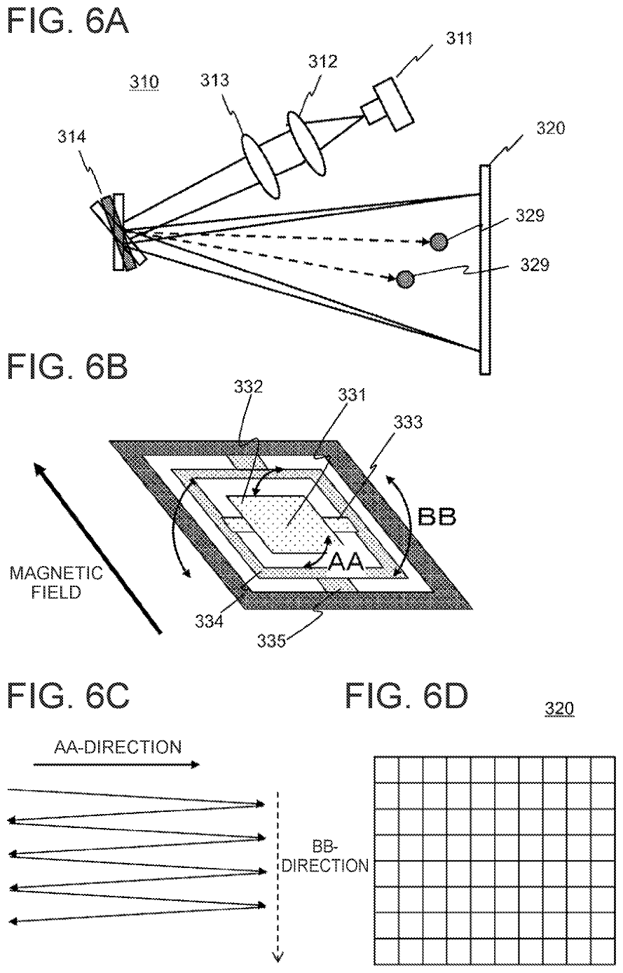

As described above, the first distance sensor 155 and the second distance sensor 156 measure distance of the first distance measurement area 155v and second distance measurement area 156v, which are predetermined two-dimensional distance measurement areas, respectively. In the following, an exemplary method of measuring distance of two-dimensional distance measurement areas by LiDAR sensors used as the first distance sensor 155 and second distance sensor 156 will be described with reference to FIG. 6A to FIG. 6D.

As illustrated in FIG. 6A, the light emitting portion 310 of a LiDAR sensor includes a laser light source 311, a collimating lens 312, a condenser lens 313, and a MEMS (Micro Electro Mechanical Systems) element 314. Elements and optical components of the light receiving side are not described herein.

A LiDAR sensor is configured to convert lights emitted from the laser light source 311 into collimated lights by the collimating lens 312, and then condenses the collimated lights by the condenser lens 313. Thereafter, using the MEMS mirror 331, the laser is scanned in a direction perpendicular to the first axis to detect the distance to an object (object 329) within the range of a two-dimensional distance measurement area 320.

A configuration of the MEMS element 314 will be described with reference to FIG. 6B. The MEMS element 314 includes the MEMS mirror 331 that reflects a light, an inner coil 332 installed on the outer periphery of the MEMS mirror 331, an inner torsion bar 333, an outer coil 334, and an outer torsion bar 335.

Applying a magnetic field to the outside to supply the inner coil 332 with the current causes, in addition to a torque (Lorentz force) that makes the MEMS mirror 331 rotate in an AA-direction of FIG. 6B, the elastic force of a torsion spring by the inner torsion bar 333 acting in the opposite direction thereto, whereby the MEMS mirror 331 vibrates in the AA-direction in a predetermined angular range. Furthermore, supplying the outer coil 334 with the current causes, in addition to a torque that makes the inner coil 332 and the MEMS mirror 331 rotate in a BB-direction of FIG. 6B, the elastic force by the outer torsion bar 335 acting in the opposite direction, whereby the MEMS mirror 331 vibrates in the BB-direction in a predetermined angular range.

This enables, as illustrated in FIG. 6C, the LiDAR sensor to realize a horizontal scanning in a predetermined range (AA-direction in FIG. 6C) and a vertical scanning in a predetermined range (BB-direction in FIG. 6C). During this, a distance value is calculated at predetermined time intervals, whereby, as illustrated in FIG. 6D, a distance value of each unit area in a range corresponding to the two-dimensional distance measurement area 320 can be obtained.

Making a unit of detection of a distance value associated with each pixel position of the first camera 135 and second camera 136 enables effective use of a result of distance measurement in the processing of an image captured by these imaging devices.

In this case, for example, storing first data, in which the imaging field of view 135v of the first camera 135 and the first distance measurement area 155v are associated with each other, and second data, in which the imaging field of view 136v of the second camera 136 and the second distance measurement area 156v are associated with each other, in advance in the memory and storage 110 enables the distance signal processor 214 to calculate a distance value in an area corresponding to each pixel position of the first camera 135 as necessary, so that a distance value for each pixel of an image acquired by the first camera 135 can be obtained. The same applies to an image acquired by the second camera 136.

### [Processing Flow]

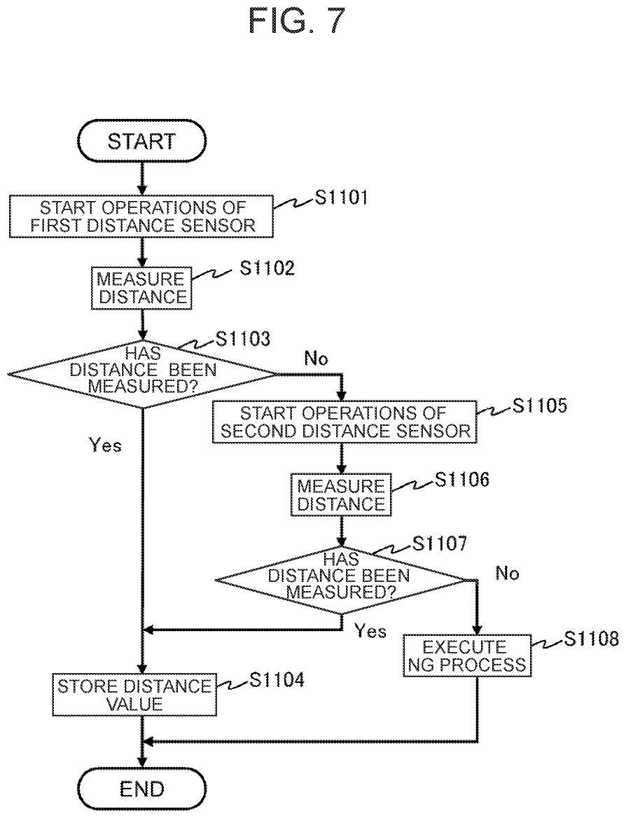

Next, a flow of a distance measurement process executed by the distance measurement controller 212 according to the present embodiment will be described. FIG. 7 illustrates a processing flow of the distance measurement process according to the present embodiment. This process is started, for example, upon reception of an instruction to start distance measurement from a user or upon activation of the smartphone 100. In the present embodiment, a result of distance measurement is used together with a result of imaging by each camera. Accordingly, the distance measurement process may be started, for example, upon activation of the first camera 135 or the second camera 136.

This process is repeatedly executed at predetermined time intervals. Each time interval is at least the time for one time scanning of the distance measurement area 320 or longer.

Hereinafter, in the present embodiment, an example of causing the first distance sensor 155, which is a middle-distance sensor, to preferentially operate will be described.

The distance sensor activation section 213 causes the first distance sensor 155 to start operations (step S1101). This starts the distance measurement by the first distance sensor 155 (step S1102).

The distance signal processor 214 determines whether the distance has been able to be measured by the first distance sensor 155 (step S1103). In this example, the distance signal processor 214 determines whether a sensor signal received from the first distance sensor 155 is a distance value or an NG signal. In the present embodiment, the first distance measurement area 155v is a target of distance measurement. For example, determination is made using a sensor signal indicating a result of distance measurement of a predetermined area (determination area), such as a predetermined area of the center, of the first distance measurement area 155v. For example, when all the sensor signals in this determination area have NG values, the distance signal processor 214 determines that the distance has not been measured. The determination criterion is defined in advance and stored in the memory and storage 110 or the like.

When determining that the distance has been measured (step S1103; Yes), the distance signal processor 214 stores the distance value that is the sensor signal in association with the time of acquisition thereof (step S1104), and completes the process. Note that the scanning mechanism of the MEMS element 314 enables identification of information (position information) for identifying the position of the first distance measurement area 155v based on the acquisition time. Thus, it may be stored in association with the position information of the first distance measurement area.

On the other hand, when the distance has not measured (step S1103; No), the distance sensor activation section 213 causes the first distance sensor 155 to stop the operations, and causes the second distance sensor 156 to start operations (step S1105). This starts the distance measurement by the second distance sensor 156 (step S1106).

The distance signal processor 214 determines whether the distance has been able to be measured by the second distance sensor 156 (step S1107). The method of determination is the same as that by the first distance sensor 155.

When determining that the distance has been measured (step S1107; Yes), the process proceeds to step S1104. On the other hand, when the distance has not been measured (step S1107; No), the distance measurement controller 212 carries out an NG process (step S1108), and then terminates the process. The NG process includes, for example, displaying, on the display 131, a message indicating that a distance value cannot be acquired, outputting a predetermined sound from the speaker 141, and the like.

As described above, the smartphone 100 according to the present embodiment comprises a distance measurement device (distance sensor 159) capable of measuring distance of the first distance measurement range 155d and distance of the second distance measurement range 156d that is different from the first distance measurement range 155d, and a processor (distance signal processor 214) configured to determine the distance to an object based on a result of distance measurement by the distance sensor 159 and output the result as a distance measurement value.

This enables a device assumed to be used in various ways, such as the smartphone 100, to measure distance around the device with high accuracy without being limited to a single distance measurement range. That is, in any usage situation of the smartphone 100, the smartphone 100 can obtain a distance value of an imaging range of the camera thereof with accuracy. Of course, the first camera 135 and the second camera 136 may be configured to be switched in response to switching of the distance sensor. Furthermore, the first distance sensor 155 and the second distance sensor 156 may be configured to be switched in response to an operation by a user selecting a camera to be used.

Furthermore, the first distance measurement range 155d contains the imaging distance 135d of the first camera 135, and the second distance measurement range 156d contains the imaging distance 136d of the second camera 136. This enables, according to the present embodiment, highly accurate measurement of distance of all imaging ranges of cameras included in a device (smartphone 100) equipped with the distance sensor 159.

The smartphone 100 is allowed to execute various processes using a distance value as obtained. Such processes include, for example, accurate focusing in imaging with cameras, and accurate occlusion for grasping a front and rear relation between an object in a real space and a virtual object in displaying virtual reality, which realize more natural virtual reality display. In the present embodiment, for example, the display controller 218 determines the front and rear relation between the object and the virtual object in the real space using a distance value, and identifies an occlusion region for displaying virtual reality.

Still further, the distance sensor 159 of the smartphone 100 according to the present embodiment includes the first distance sensor 155 configured to measure distance of the first distance measurement range 155d to obtain a distance measurement value, and the second distance sensor 156 configured to measure distance of the second distance measurement range 156d to obtain a distance measurement value. The smartphone 100 further includes the distance sensor activation section 213 configured to activate the second distance sensor 156 when a distance measurement value by the first distance sensor 155 has not been obtained.

As described above, in the present embodiment, the first distance sensor 155, which is a middle-distance sensor, is activated first, and when the distance to be measured does not fall within a distance measurement range (first distance measurement range 155d) of the first distance sensor 155, the second distance sensor 156 is then activated. In the case of the smartphone 100, the middle-distance sensor tends to be frequently used. Accordingly, the smartphone 100 configured as above is allowed to suppress the unnecessary use of the light emitting device and the like of the unnecessary distance sensor 159, and thus suppress consumption of a battery.

In the present embodiment, an optical axis direction of a camera and a distance measurement direction of the distance sensor 159, which correspond to each other, are configured to be matched. Thus, a distance value acquired by the distance sensor 159 can be accurately associated with a pixel value acquired by each camera. This improves the accuracy of the processes of augmented reality, and the like.

In the embodiment described above, the distance sensor to be used is switched by activating the first distance sensor 155 and the second distance sensor 156 by software, respectively, however, the present invention is not limited thereto. For example, providing a changeover switch in a manner of hardware and outputting a switching instruction to this changeover switch by software may enable switching of the distance sensor to be used.

### First Modification

In the embodiment described above, the first distance sensor 155, which is a middle-distance sensor, is firstly activated, however, the present invention is not limited thereto. For example, the second distance sensor 156, which is a short-distance sensor, may be preferentially activated depending on the use environment. Furthermore, a user may be allowed to decide which sensors to be preferentially activated.

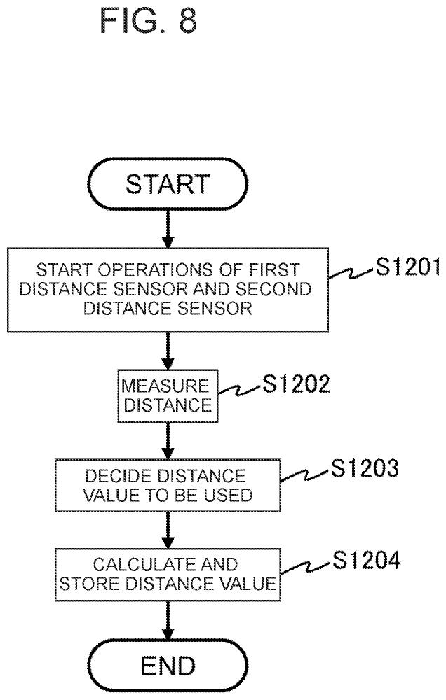

Furthermore, both the distance sensors may be activated simultaneously. FIG. 8A illustrates a processing flow in this case. The trigger and frequency of execution of this process are the same as those of the distance measurement process according to the embodiment described above.

The distance sensor activation section 213 activates the first distance sensor 155 and the second distance sensor 156 (step S1201). This starts the distance measurement by the both the distance sensors (step S1202).

The distance signal processor 214 decides which distance signal is to be adopted among those by both the distance sensors (step S1203). In this example, the distance signal processor 214 makes determination using sensor signals of the determination area acquired from both the distance sensors. That is, the distance signal processor 214 decides to employ the one having a distance value that is not an NG signal, among the sensor signals of the discrimination area.

The distance signal processor 214 stores the distance value acquired from the distance sensor decided to be adopted in association with the time of acquisition thereof (step S1204), and completes the process.

Thus, activating both the sensors and executing the process causes a situation that sensor signals had already been acquired from both the sensors at the time when determining which measurement results by the distance sensors to be adopted. This can increase the speed of processing.

### Second Modification

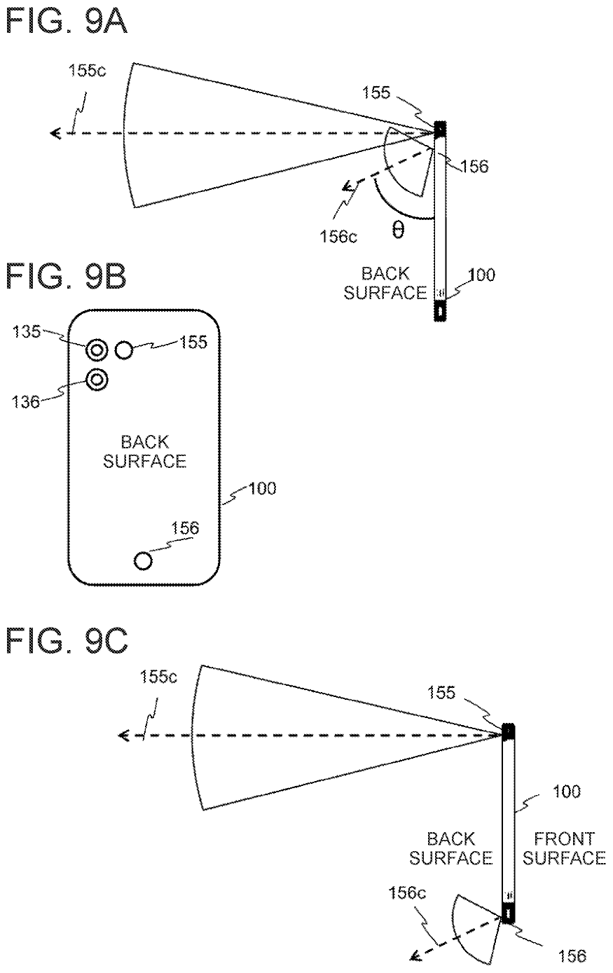

In the embodiment described above, the distance measurement direction 156c of the second distance sensor 156, which is a short-distance sensor, is made match with the optical axis direction of the second camera 136. However, the distance measurement direction 156c of the second distance sensor 156 is not limited to the direction described above. For example, as illustrated in FIG. 9A, the distance measurement direction 156c of the second distance sensor 156 may be directed downward. That is, the second distance sensor 156 may be installed in a direction in which the distance measurement direction 156c thereof has a predetermined angle θ with respect to the vertical direction.

When the portable terminal is the smartphone 100, in many cases, the second distance sensor 156, which is a short-distance sensor, measures distance of the range below the smartphone 100, for example, around the hand of a user. In addition, the second camera 136 for capturing an image of a short distance is often used to capture a QR code (registered trademark), and in order to read the QR code, firstly, the smartphone 100 is moved so that the QR code is positioned to face the center of the smartphone 100. Thus, directing the distance measurement direction 156c of the second distance sensor 156 downward allows the smartphone 100 to measure the distance to the QR cord first, and then matching the position of the camera mounted on the upper portion of the smartphone 100 to the QR code. This enables accurate measurement of close distance.

There is a case that, in the smartphone 100, the distance to an imaging target object is measured firstly using the distance sensor 159, and then, based on the result of the measurement, whether to activate the first camera 135 for capturing an image of a middle-distance or the second camera 136 for capturing an image of a close distance is decided. In such a case, with the configuration as in the present modification, the middle-distance and the short distance can be measured with high accuracy with the smartphone 100 being kept in a substantially vertical state. This allows the smartphone 100 to decide which cameras to be activated based on a result of the highly accurate measurement, which results in increase in the probability that a desired camera is activated and thus improvement in the usability of the smartphone 100.

### Third Modification

Furthermore, the second distance sensor 156 is not limitedly arranged to the position according the embodiment described above. For example, as illustrated in FIG. 9B, the second distance sensor 156 may be installed at the lower portion of the smartphone 100. FIG. 9B illustrates an example in which the smartphone 100 is installed at the center of the lower portion. As described above, in many cases, a short-range sensor measures distance of a range positioned at the downward, and thus this arrangement is more reasonable.

Still further, in this arrangement, as illustrated in FIG. 9C, the distance measurement direction 156c of the second distance sensor 156 may be directed downward. This improves the usability for the same reason as described above.

### Fourth Modification

In the embodiment described above, LiDAR sensors by MEMS systems are used as the distance sensor 159. However, the distance sensor 159 is not limited thereto. For example, technology using pattern light emission may be adopted.

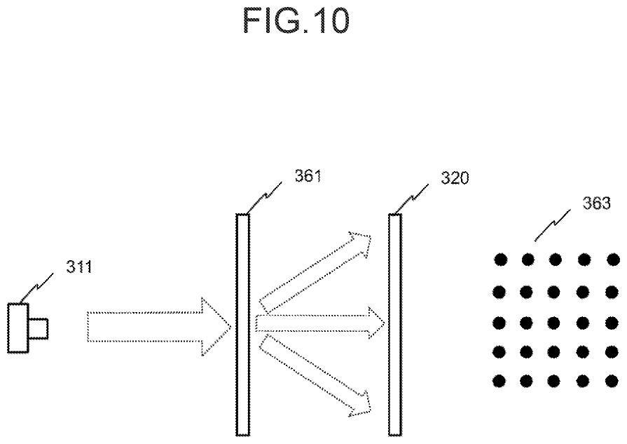

FIG. 10 illustrates a configuration of the distance sensor 159 of a pattern light emission system. In the pattern light emission system, the distance sensor 159 includes the laser light source 311 and a diffraction grating 361. FIG. 10 omits to illustrate some components such as the collimating lens. In the present system, the diffraction grating 361 diffracts a laser light incident on the diffraction grating 361 and converts it into various shapes and irradiation patterns 363. Then, the light receiving portion 340 including a light receiving element calculates the distance to each point of the distance measurement area 320 based on the time until the emitted light returns and the distortion of the irradiation patterns 363. Changing the positions of the lens (not illustrated) and diffraction grating causes switching of the spread angle of the irradiation pattern and the power of the laser to be irradiated, whereby the measurement range can be switched.

### Fifth Modification

In the embodiment described above, the example in which the portable terminal is the smartphone 100 has been described, however, the portable terminal is not limited thereto. For example, it may be an HMD 100h.

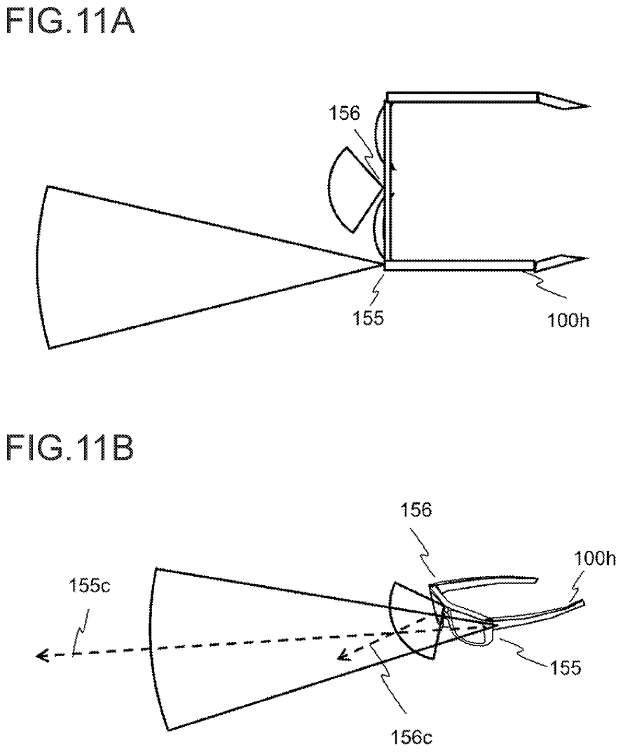

FIG. 11A illustrates an example of the arrangement of the first distance sensor 155 and second distance sensor 156 in this case. As illustrated in FIG. 11A, for example, the first distance sensor 155 is installed at an end portion in the width direction of the upper frame of the lens (display). The second distance sensor 156 is installed at the center of the upper frame.

In this case, the distance measurement direction 155c of the first distance sensor 155 and the distance measurement direction 156c of the second distance sensor 156 may be the same. Alternatively, as illustrated in FIG. 11B, the distance measurement direction 156c of the second distance sensor 156 may be directed downward by tilting it by a predetermined angle with respect to the vertical direction.

In the HMD 100h, the distance measurement direction is substantially aligned with the line-of-sight direction of a user. The line-of-sight direction of a user who is looking at close distance is often directed downward. Thus, setting the distance measurement direction 156c of the second distance sensor 156 to be directed downward enables detection of the distance in the direction along the line-of-sight direction of the user.

Note that, when the portable terminal is the HMD 100h and the distance measurement direction of the second distance sensor 156 is directed downward as illustrated in FIG. 11B, the HMD 100h may detect the line-of-sight direction of a user, and then decide or change the distance sensor 159 to be used based on a result of the detection.

For detection of the line-of-sight, for example, a result of imaging by the third camera 137, which is an in-camera, is used. Capturing an image of the eye of a user using the third camera 137 and analyzing the captured image by a conventional method enables detection of the line-of-sight direction of the user. When the line-of-sight direction of the user is aligned with the distance measurement direction 156c of the second distance sensor 156 within a predetermined range, a result of the distance measurement by the second distance sensor 156 is used as a measured value (distance value).

### Sixth Modification

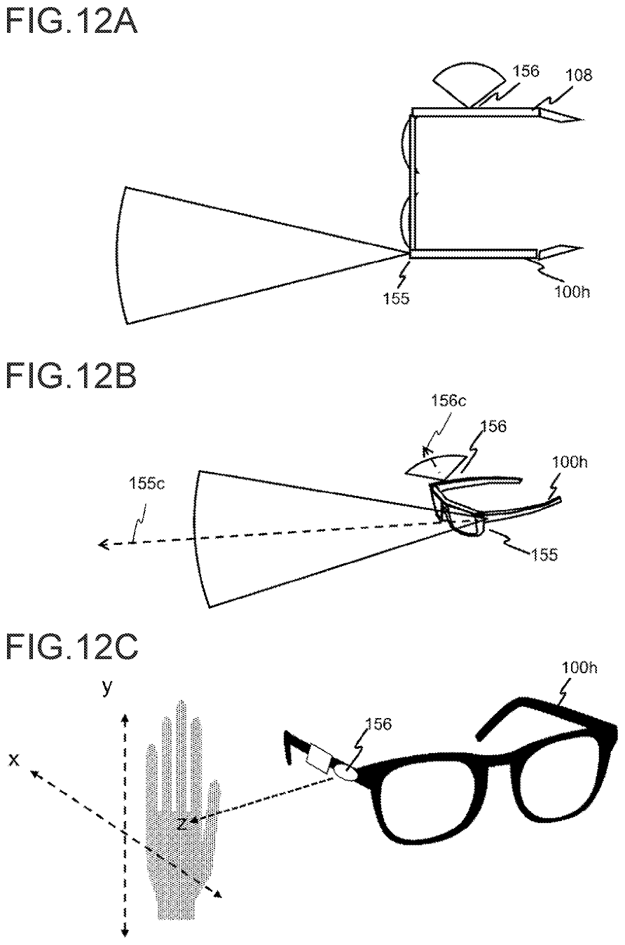

When the portable terminal is the HMD 100h, the second distance sensor 156, which is a short-distance sensor, may be installed on a temple 108 of the eyeglasses. FIG. 12A and FIG. 12B illustrate the arrangement in this case, which is for detecting an instruction by means of a gesture.

For example, as illustrated in FIG. 12C, defining a xyz-coordinate system for gesture operations in advance allows the second distance sensor 156 to measure the distance to each unit area within the second distance measurement area 156v, by which a gesture operation can be detected.

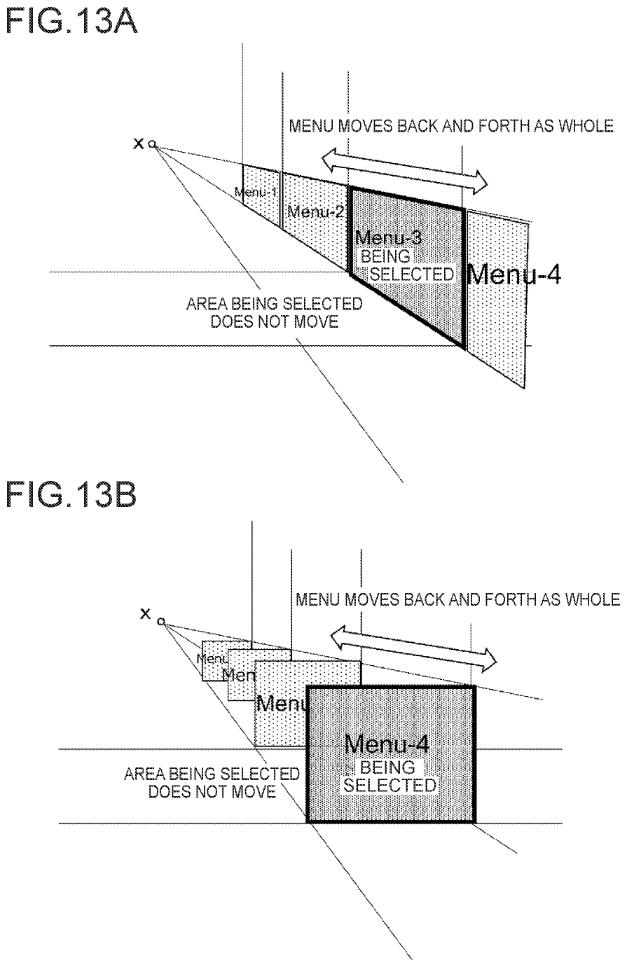

FIG. 13A and FIG. 13B illustrate a display example of a menu in this case. In this example, a menu is displayed as if it appeared in the depth direction (x-axis direction). A user can scroll the menu, for example, by moving his or her hand back and forth (in the x-axis direction) with respect to the lateral direction of the face. Displaying of a menu is controlled by the display controller 218.

For example, a user selects, from a menu, an option arranged at a center position beside the head of a user, and this changes a display mode (for example, color). The user is allowed to make a selection by bringing his or her hand closer in the Z-axis, touching a touch sensor provided with the HMD 100h, or the like. Upon receiving a selection instruction from the user, the HMD 100h determines that, in the menu, the option displayed at the center position beside the head at that time has been selected, and then carries out the process.

The arrangement according to the present modification allows a gesture as an operation instruction to the HMD 100h to be performed on the side without obstructing the visual field thereof by the gesture, and thus can improve the usability. Furthermore, displaying, as a new user interface, a menu as described above enables the menu to be displayed with the relevance to the motion of the hand being increased, and can improve the operability.

In this case, another second distance sensor 156, which is a short-distance sensor, may be installed at the center of an upper portion of the front in the same manner as the modification described above.

### Second Embodiment

Next, a second embodiment of the present invention will be described. The smartphone 100 according to the first embodiment includes the distance sensor 159 configured with a plurality of distance sensor for different distance measurement ranges. On the other hand, the smartphone 100 according to the present embodiment includes a distance sensor of which a distance measurement range is variable, and switches the distance measurement range depending the distance to an object to be measured.

Hereinafter, the present embodiment will be described with focusing on a configuration different from that of the first embodiment.

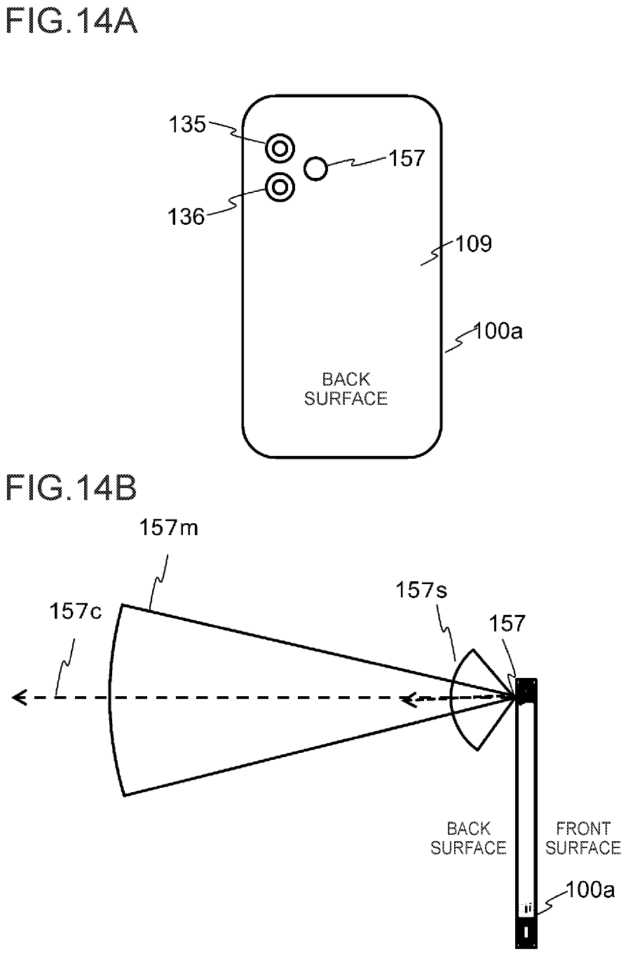

FIG. 14A is a back surface view of a smartphone 100a, and FIG. 14B is a side surface view of the smartphone 100a. In the following, the configuration relating to the present embodiment will be mainly described.

As illustrated in FIG. 14A, the smartphone 100a includes the first camera 135, the second camera 136, and a variable distance sensor 157 on the back surface thereof. The appearance of the smartphone 100a other than the above is the same as that of the first embodiment.

In the present embodiment, as illustrated in FIG. 14A, the variable distance sensor 157 is installed at an intermediate position between the first camera 135 and the second camera 136 in the longitudinal direction (vertical direction) of the smartphone 100a. As illustrated in FIG. 14B, a distance measurement direction 157c of the variable distance sensor 157 is the same as optical axis directions of the cameras.

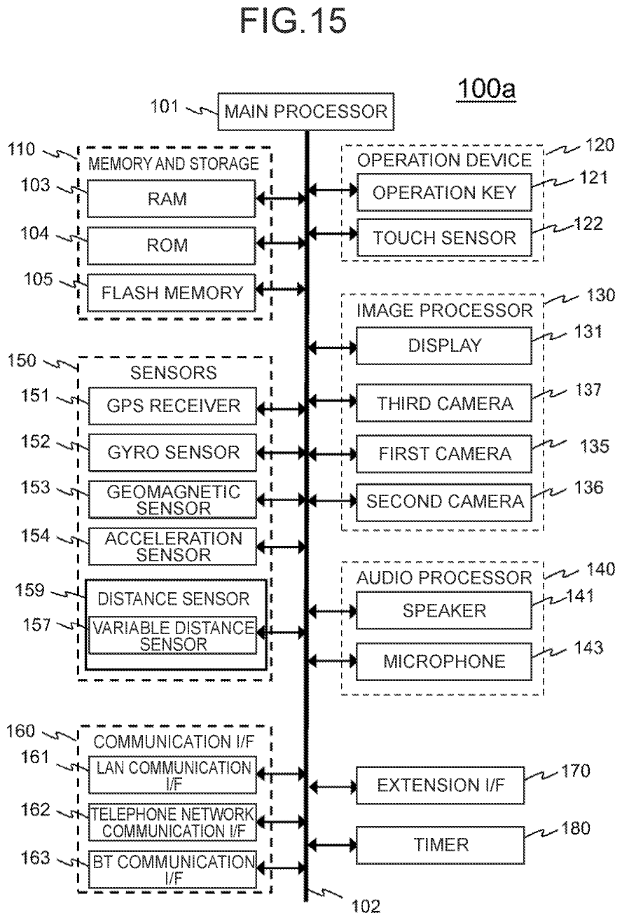

FIG. 15 illustrates a hardware configuration of the smartphone 100a according to the present embodiment. In FIG. 15, the components common to those of the first embodiment are provided with the same reference signs. As illustrated FIG. 15, the smartphone 100a according to the present embodiment includes the variable distance sensor 157 as the distance sensor 159 instead of the first distance sensor 155 and the second distance sensor 156.

The variable distance sensor 157 is a distance sensor capable of switching the distance measurement range in accordance with an instruction from the main processor 101. In the present embodiment, the variable distance sensor 157 is configured to switch the distance measurement range between a middle-distance sensing setting for the distance measurement range for a middle-distance (scanning range is indicated by 157m of FIG. 14B) and a short-distance sensing setting for the distance measurement range for short distance (scanning range is indicated by 157s of FIG. 14B). In the same manner as the first embodiment, for example, the middle-distance is equal to or more than 30 cm and 5 m or less, and the short distance is less than 30 cm.

In each setting, the variable distance sensor 157 outputs a distance value when the distance to an object is within the set distance measurement range. On the other hand, when the distance to the object is out of the set range, the variable distance sensor 157 outputs an NG signal instead of outputting a distance value.

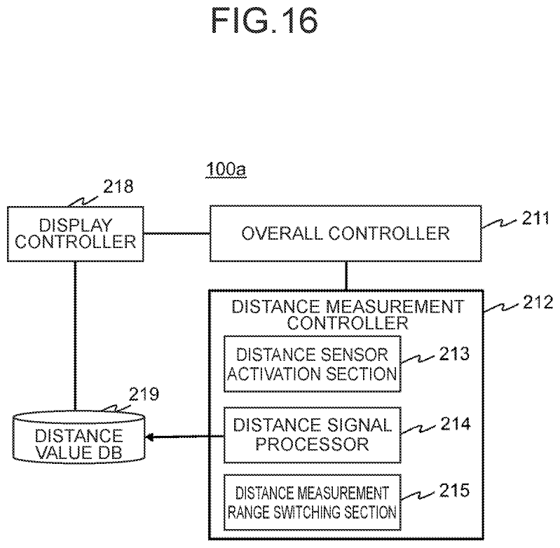

FIG. 16 is a functional block diagram of the smartphone 100a, which relates to the functions of the present embodiment. As illustrated in FIG. 16, the smartphone 100a according to the present embodiment includes the overall controller 211, the distance measurement controller 212, and the display controller 218, and the distance measurement controller 212 includes the distance sensor activation section 213, a distance measurement range switching section 215, and the distance signal processor 214. The smartphone 100a further includes the distance value DB 219 in which a distance value as acquired is stored. The configurations having the same names have the same functions as those of the first embodiment, and thus the repetitive explanation therefor will be omitted in the following.

Note that the distance sensor activation section 213 according to the present embodiment is configured to activate the variable distance sensor 157.

The distance measurement range switching section 215 outputs, to the variable distance sensor 157, an instruction for switching the distance measurement range of the variable distance sensor 157.

In the present embodiment, as the variable distance sensor 157, for example, a LiDAR sensor by a MEMS system may be used in the same manner as the distance sensor 159 according to the first embodiment. The variable distance sensor 157 switches the distance measurement range by, for example, changing the power of a laser light output from the laser light source 311. Specifically, for sensing a short distance, the light emission power is suppressed as compared with sensing of a middle-distance. This is because, in sensing of a short distance, the amount of light increases and thus the light receiving element is saturated. The light emission power for sensing a middle-distance and the light emission power for sensing a short distance are defined in advance and stored in the memory and storage 110. The distance measurement range switching section 215 issues an emission instruction to the variable distance sensor 157 (laser light source 311) so as to cause it to emit a light with either the emission power.

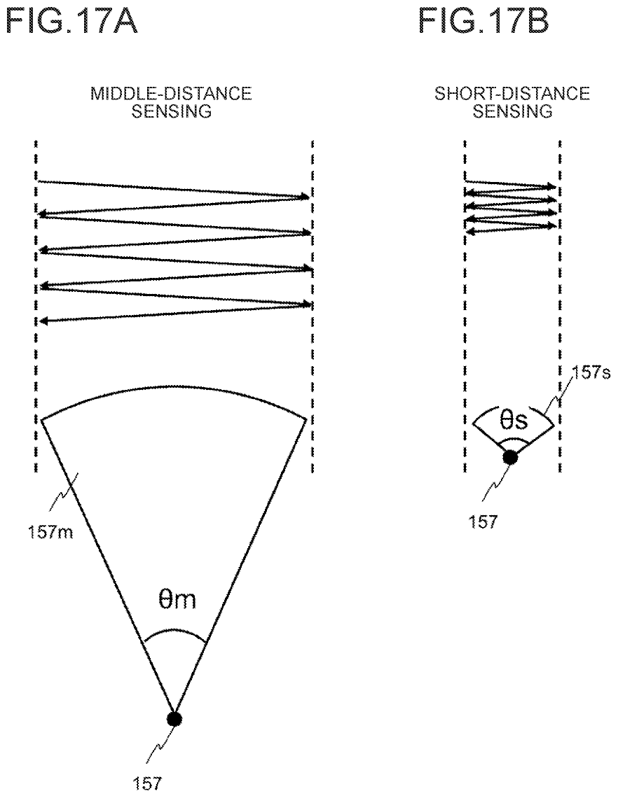

The variable distance sensor 157 may be configured to switch the distance measurement range, for example, by varying the scanning range (157m, 1157s). Specifically, as illustrated in FIG. 17A and FIG. 17B, for sensing a short distance, the scanning range is made wider as compared with sensing of a middle-distance. Specifically, a scanning angle (θm, θs) is varied. An object appears large at a short distance, and thus the scanning range for a short distance is widened as much as possible. As described above, the scanning range varies in response to the magnitude of the current to be flown through the inner coil 332 and outer coil 334 of the MEMS element 314. The magnitude of the current in sensing of a middle-distance and the magnitude of the current in sensing of a short distance are defined in advance. The distance measurement range switching section 215 outputs an instruction to the variable distance sensor 157 to cause it to flow the current with either the magnitude.

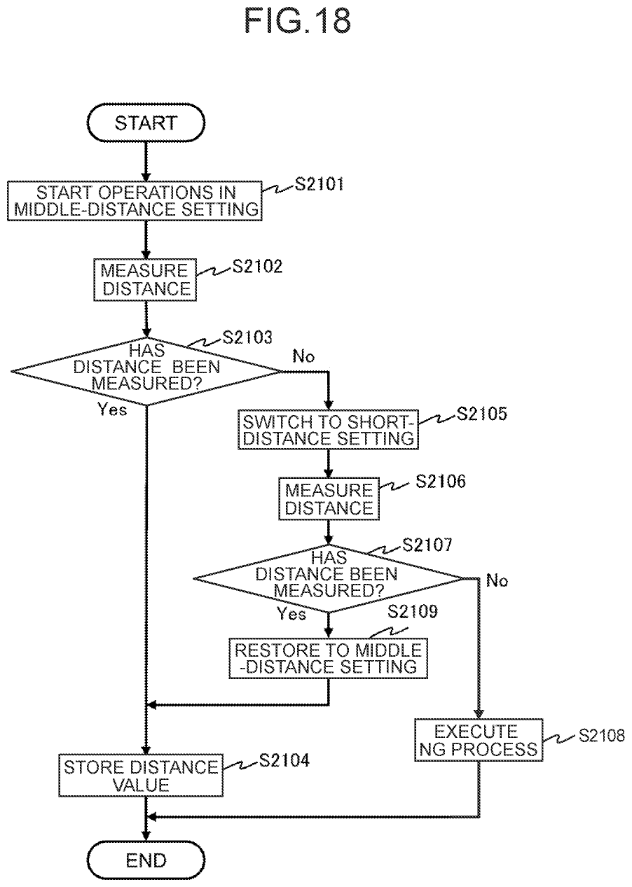

Next, a flow of a distance measurement process by the distance measurement controller 212 according to the present embodiment will be described. FIG. 18 illustrates a processing flow of the distance measurement process according to the present embodiment. This process is started by the same trigger as that of the first embodiment. The frequency of repetition thereof is also the same as that of the first embodiment.

Hereinafter, in the present embodiment, it is assumed that the variable distance sensor 157 is set such that the initial range thereof is set to the middle-distance sensing setting.

The distance sensor activation section 213 activates the variable distance sensor 157 and causes it to start the operations (step S2101). This starts the distance measurement for the middle-distance (step S2102).

The distance signal processor 214 determines whether the distance has been measured in the middle-distance sensing setting (step S2103). In the same manner as the first embodiment, the distance signal processor 214 determines the above based on whether a sensor signal in a predetermined area of the distance measurement area 320 has a distance value or a NG value.

When determining that the distance has been measured (step S2103), the distance signal processor 214 stores the obtained distance value in the database (step S2104), and then completes the process. In this embodiment, in the same manner as the first embodiment, the distance value is stored in association with the time of acquisition thereof (or position information of the distance measurement area 320).

On the other hand, when it is determined that the distance has not able to been measured (step S2103; No), the distance measurement range switching section 215 switches the distance measurement range of the variable distance sensor 157. In the present embodiment, it is switched to the short-range sensing setting (step S2105). This starts the distance measurement in the short-distance sensing setting (step S2106).

Then, the distance signal processor 214 determines whether the distance has been measured in the short-distance sensing setting (step S2107). When the distance has been measured, the distance measurement range switching section 215 restores the setting to the middle-distance sensing setting (step S2109), and proceeds the process to step S2104.

On the other hand, when the distance has not been able to be measured, the distance signal processor 214 carries out the NG process (step S2108) in the same manner as the first embodiment, and terminates the process.

Note that, in the embodiment described above, the distance measurement range switching section 215 restores the setting to the middle-distance sensing setting after the measurement by the short-distance sensing setting, however, this step may not be necessarily executed. In this case, the next measurement is started in the short-range sensing setting. Then, when an NG value is obtained in step S2103, the distance measurement range switching section 215 switches the setting to the medium-distance sensing setting in step S2105.

For example, with short repetition intervals, there is often the case that objects to be measured does not greatly change. In such a case, it is highly likely that the distance measurement range is the same as that of the previous time, and thus the setting described above rather can make the process more efficient.

As described above, the smartphone 100a according to the present embodiment includes the distance sensor 159 capable of measuring distance of a wide range around the smartphone 100a in the same manner as the first embodiment. The distance sensor 159 can measure the distance of the range and area which have been associated with the imaging distance and imaging field of view of each camera of the smartphone 100a. With this configuration, the same effects as those of the first embodiment can be obtained in the second embodiment.

Furthermore, the distance sensor 159 of the smartphone 100a according to the present embodiment includes the variable distance sensor 157 configured such that the distance measurement range thereof can be switched between the first distance measurement range 155d and the second distance measurement range 156d, and the distance measurement range switching section 215 configured to switch the distance measurement range of the variable distance sensor 157. The distance measurement range switching section 215 switches the distance measurement range of the variable distance sensor 157 to the second distance measurement range 156d when the distance measurement range of the variable distance sensor 157 has been set to the first distance measurement range 155d and a distance measurement value cannot be obtained. In the above, the example in which the distance measurement range is switched between the two modes for the middle-distance and the short-distance has been described, however, it may be switched in multi-stage.

As described above, the present embodiment includes the variable distance sensor 157 capable of measuring distance of a plurality of distance measurement ranges. Thus, in the present embodiment, only one distance sensor is required, which can reduce the cost. In addition, the arrangement of the distance sensor 159 on the smartphone 100a is less limited.

As in the first embodiment, a LiDAR sensor by a pattern light emitting system may be used in the present embodiment as well.

### Seventh Modification

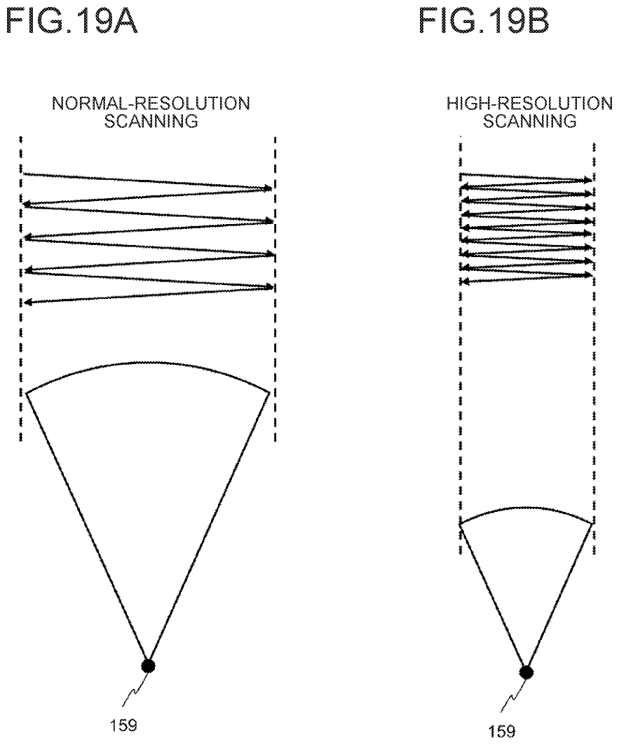

In each of the embodiments and modifications described above, the resolution may be changed in the same distance measurement range. Controlling the rotational speed of the MEMS mirror 331 without changing the speed of the emission pulses enables the resolution to be varied. For example, FIG. 19A illustrates scanning with a normal resolution, and FIG. 19B illustrates scanning with a high resolution. As illustrated in FIG. 19A and FIG. 19B, the slower the rotational speed (speed of vibration) of the MEMS mirror 331 is made, the denser the scanning can be performed, thereby realizing enhancement of the resolution (highly improved definition).

For example, when an object has a finely uneven surface or an object does not have face shapes but is composed of thin rod-shaped parts, the distance measurement controller 212 sets the high-definition scanning and sensing, and controls the operations of the distance sensor 159.

### Eighth Modification

In the embodiments and modifications described above, the distance sensor 159 is configured to output an NG signal when the distance is not within the distance measurement range. However, the distance sensor 159 is not limited thereto. For example, when the distance is out of the distance measurement range, the distance sensor 159 may display the limit value of the distance measurement range so as to show the distance is out of the range. In this case, for each distance sensor 159, a range in which distance can be accurately measured is predetermined as the distance measurement range, and stored in the memory and storage device or the like.

In this case, in the example of the first embodiment, whether a distance value obtained by the first distance sensor 155 falls within a value of the distance measurement range of the first distance sensor 155 is determined in step S1103 of the distance measurement process. When the value falls within the range of the first distance sensor 155, the process proceeds to step S1104. On the other hand, when the value is out of the range of the first distance sensor 155, the process proceeds to step S1105.

### Ninth Modification

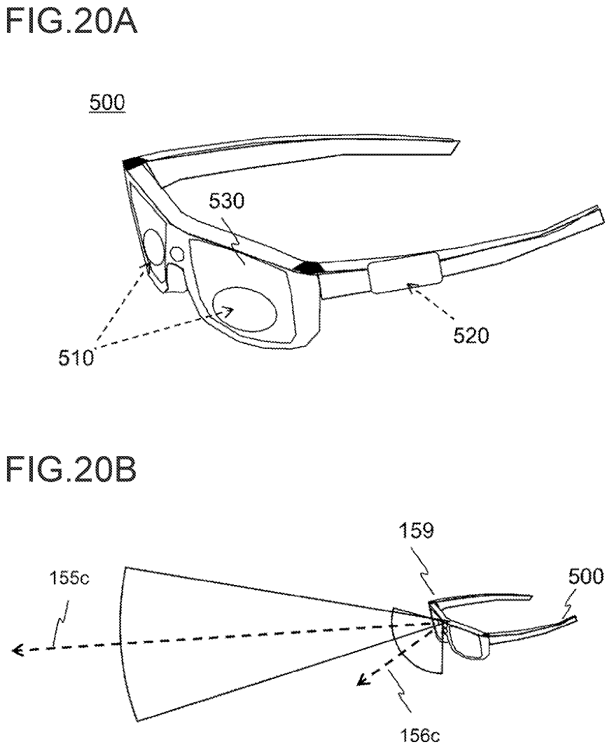

Furthermore, the distance sensor 159 according to each of the embodiment and modifications described above may be applied to eyeglasses (electronic glasses) having a variable focus lens. For example, as disclosed in WO 2013/088630 (Patent Literature 3), electronic glasses 500 having a variable focus lens 530 includes a liquid crystal panel 510 for diffraction provided in a portion of a lens and a controller 520 for controlling the voltage applied to the liquid crystal panel 510. FIG. 20A illustrates the appearance of the electronic glasses.

The variable focus lens 530 is a lens whose refractive index varies depending on the voltage to be applied. For example, it is set such that applying the voltage causes the refractive index for myopia (small refractive index) while applying no voltage causes the refractive index for hyperopia (large refractive index).

As illustrated in FIG. 20B, the electronic glasses 500 is provided with the distance sensor 159 according to the embodiments or modifications described above. The distance sensor 159 is attached to, for example, the center of an upper portion of the variable focus lens 530 of the frame of the electronic glasses 500.

In the case of the distance sensor 159 according to the first embodiment, the first distance sensor 155 may be installed such that the distance measurement direction thereof is directed toward the front direction of the electronic glasses 500, and the second distance sensor 156 for measuring a short-distance may be installed such that the distance measurement direction thereof is directed downward by a predetermined angle with respect to the front direction of the electronic glasses 500.

The controller 520 controls the voltage to be applied to the variable focus lens 530 depending on a distance value from the distance sensor 159. Specifically, upon receiving a distance value of the short-distance range which is less than a predetermined threshold value, the controller 520 applies the voltage to the variable focus lens 530. This causes the variable focus lens 530 to have a refractive index for myopia.

That is, providing the distance sensor 159 enables calculation of the distance to an object in a direction of the line-of-sight of a user (distance measurement direction of the distance sensor 159), and thus change in the refractive index of the variable focus lens 530 depending on the distance as obtained.

In the example disclosed in Patent Literature 3, various sensors are used to detect the tilting of the head of a user, and, for example, upon detecting that the user is facing downward to read a book, the voltage is applied to cause the refractive index for myopia. Thus, a situation that the user is looking at something near without tilting his or her head does not cause the refractive index for myopia. Moreover, a situation that the user is looking down with the head tilted to go down the stairs causes change to the refractive index for myopia even though the refractive index for hyperopia is desirable for such a situation.

However, according to the present modification, the voltage is applied to the variable focus lens depending on the distance to an object in a direction of the line-of-sight of a user, which can avoid the problems described above, and thus results in the electronic glasses 500 with higher convenience. Note that the same functions as those of the HMD 100h according to the fifth modification, such as AR displaying function, may be further mounted on the electronic glasses 500.

### Tenth Modification

In each of the embodiments and modification described above, the example of providing two types of distance measurement ranges, which are for middle-distance and short-distance, has been described. However, the number of ranges is not limited thereto. It may be three or more types of distance measurement ranges. In this case, in the first embodiment, the distance sensors 159 are to be provided such that the number thereof corresponds to the number of stages of the range measurement ranges. In the second embodiment, the distance measurement range is to be varied stepwise so as to be able to correspond to the number of distance measurement ranges.

Furthermore, in each of the embodiments and modifications described above, the distance measurement range and distance measurement area of the distance sensor 159 are associated with the imaging distance and imaging field of view of each camera provided in the portable terminal, however, it is not limited thereto. The distance measurement range and distance measurement area of the distance sensor 159 may be set to be completely independent from the imaging distance and imaging field of view of each camera.

The present invention is not limited to the embodiments and modifications described above, but includes other various modifications. For example, the embodiments described above have been explained in detail in order to clarify the present invention, but are not necessarily limited to those having all the features as described. In addition, a part of the configuration of the present embodiments and modifications can be replaced with that of other embodiments and modifications, and the features of other embodiments and modifications can be added to the configuration of the present embodiments and modifications. Furthermore, it is possible to add, delete, or replace other configurations with respect to a part of the configuration of the present embodiments and modifications.

Some or all the configurations, functions, processing units, and processing means described above may be implemented by hardware, for example, by designing them with an integrated circuitry. In addition, the configurations and functions described above may be implemented by software by interpreting and executing programs in which the processor implements the respective functions. Information such as programs, tables, and files for implementing various functions can be placed in recording devices such as a memory, hard disk, and solid-state drive (SSD), or recording media such as an IC card, SD card, and DVD.

Furthermore, the control lines and information lines which are considered to be necessary for the purpose of explanation are indicated herein, but not all the control lines and information lines of actual products are necessarily indicated. It may be considered that almost all the configurations are actually connected to each other.

### REFERENCE SIGNS LIST

100: smartphone, 100a: smartphone, 100h: HMD, 101: main processor, 102: system bus, 103: RAM, 104: ROM, 105: flash memory, 109: casing, 110: memory and storage, 120: operation device, 121: operation key, 122: touch sensor, 130: image processor, 131: display, 135: first camera, 135d: imaging distance, 135v: imaging field of view, 136: second camera, 136d: imaging distance, 136v: imaging field of view, 137: third camera, 140: audio processor, 141: speaker, 143: microphone, 150: sensors, 151: GPS receiver, 152: gyro sensor, 153: geomagnetic sensor, 154: acceleration sensor, 155: first distance sensor, 155c: distance measurement direction, 155d: first distance measurement range, 155v: first distance measurement area, 156: second distance sensor, 156c: distance measurement direction, 156d: second distance measurement range, 156v: second distance measurement area, 157: variable distance sensor, 157c: distance measurement direction, 159: distance sensor, 160: communication I/F, 161: LAN communication I/F, 162: telephone network communication I/F, 163: BT communication I/F, 170: extension interface, 180: timer,
211: overall controller, 212: distance measurement controller, 213: distance sensor activation section, 214: distance signal processor, 215: distance measurement range switching section, 218: display controller, 219: distance value DB,
310: light emitting portion, 311: laser light source, 312: collimating lens, 313: condenser lens, 314: MEMS element, 320: distance measurement area, 329: object, 331: MEMS mirror, 332: inner coil, 333: inner torsion bar, 334: outer coil, 335: outer torsion bar, 340: light receiving portion, 351: pulse laser light, 352: reflection light, 353: emission light, 354: reflection light, 361: diffraction grating, 363: irradiation pattern,
500: electronic glasses, 510: liquid crystal panel, 520: controller, 530: variable focus lens

1. A portable terminal, comprising:
at least one camera;
a distance measurement device capable of measuring a distance of a first distance measurement range included in an imaging distance of the at least one camera and a distance of a second distance measurement range different from the first distance measurement range; and
a processor configured to determine a distance to an object based on a result of distance measurement by the distance measurement device and output the result as a distance measurement value.

2. The portable terminal according to claim 1, wherein
the distance measurement device includes:
a first distance sensor configured to measure the distance of the first distance measurement range to obtain the result of distance measurement; and
a second distance sensor configured to measure the distance of the second distance measurement range to obtain the result of distance measurement.

3. The portable terminal according to claim 2, further comprising a distance sensor activation section configured to activate the second distance sensor when the result of distance measurement by the first distance sensor has not been obtained.

4. The portable terminal according to claim 1, further comprising:
a variable distance sensor configured such that a distance measurement range thereof can be switched between the first distance measurement range and the second distance measurement range; and
a distance measurement range switching section configured to switch the distance measurement range of the variable distance sensor, wherein
the variable distance sensor is further configured to:
when the distance measurement range is set to the first distance measurement range, measure the distance of the first distance measurement range to obtain the result of distance measurement; and
when the distance measurement range is set to the second distance measurement range, measure the distance of the second distance measurement range to obtain the result of distance measurement, and
the distance measurement range switching section is configured to switch the distance measurement range of the variable distance sensor to the second distance measurement range when the result of distance measurement has not been obtained under a condition that the distance measurement range of the variable distance sensor is set to the first distance measurement range.

5. The portable terminal according to claim 2, wherein a direction of a center of distance measurement of the second distance sensor is tilted by a predetermined angle with respect to the portable terminal.

6. The portable terminal according to claim 2, wherein the second distance sensor is installed at a center of a lower portion of the portable terminal.

7. The portable terminal according to claim 1, wherein
the at least one camera comprises a first camera and a second camera,
the first distance measurement range contains an imaging distance of the first camera, and
the second distance measurement range contains an imaging distance of the second camera.

8. The portable terminal according to claim 2, further comprising, as the at least one camera,
a first camera of which an imaging distance is contained in the first distance measurement range; and
a second camera of which an imaging distance is contained in the second distance measurement range,
wherein a direction of a center of distance measurement of the first distance sensor and a direction of a center of distance measurement of the second distance sensor are substantially the same as an optical axis of a lens of the first camera and an optical axis of a lens of the second camera, respectively.

9. The portable terminal according to claim 7, wherein the portable terminal activates, among the first camera and the second camera, one whose imaging distance contains the result of distance measurement output from the distance measurement device.

10. The portable terminal according to claim 7, further comprising:
first data that associates an imaging field of view of the first camera with a distance measurement area in distance measurement of the first distance measurement range; and
second data that associates an imaging field of view of the second camera and a distance measurement area in distance measurement of the second distance measurement range,
wherein the portable terminal calculates a distance value corresponding to each pixel position of one of the first camera and the second camera based on the result of distance measurement by the distance measurement device.

11. The portable terminal according to claim 1, further comprising a display controller configured to determine a front and rear relation between an object in a real space and a virtual object using the distance measurement value, identify an occlusion area, and display the objects.

12. The portable terminal according to claim 1, wherein the portable terminal is a smartphone.

13. The portable terminal according to claim 1, wherein
the portable terminal is a head-mounted display,
the head-mounted display comprises a line-of-sight sensor configured to detect a line-of-sight direction, and
the distance measurement device decides which distance of the first distance measurement range or that of the second distance measurement range is to be measured depending on the line-of-sight direction detected by the line-of-sight sensor.

14. The portable terminal according to claim 2, wherein
the portable terminal is a head-mounted display,
the second distance measurement range is for a short distance of 30 cm or less from the head-mounted display, and
the second distance sensor is installed at a side portion of the head-mounted display to measure a side of the head-mounted display.

15. The portable terminal according to claim 1, wherein the second distance measurement range is for a short distance within 30 cm from the portable terminal.

16. Electronic glasses provided with a variable focus lens allowing a refractive index thereof to be changed from a refractive index for hyperopic to a refractive index for myopic by application of a voltage, comprising:
a controller configured to control the voltage to be applied to the variable focus lens; and
a short-distance sensor configured to measure a distance of a short-distance range, the distance being from the variable focus lens and less than a predetermined threshold value, and output a distance to an object contained within the short-distance range as a distance measurement value,
wherein the controller applies the voltage to the variable focus lens upon output of the distance measurement value by the short-distance sensor.
